(19) United States
(12) Patent Application Publication
(10) Pub. No.: US 2006/0076938 A1
(43) Pub. Date: Apr. 13, 2006

(54) Linearly regulated power supply

(75) Inventor: Wu Jiang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/250,130

(22) Filed: Oct. 13, 2005

(30) Foreign Application Priority Data
Oct. 13, 2004 (CN) 200410051870.8

(51) Int. Cl. G05F 1/618

(52) U.S. Cl. 323/272

(57) ABSTRACT

A linearly regulated power supply is provided for providing a regulated load voltage to a load. In a preferred embodiment, the linearly regulated power supply includes: a voltage reference circuit for providing a first voltage reference; a resistive voltage divider connected to the voltage reference circuit for receiving the first voltage reference and then providing a second voltage reference; an error amplifier for receiving the second voltage reference and providing a controlling voltage; and a regulating circuit controlled by the controlling voltage, the regulating circuit receiving a source voltage and then providing a load voltage to a load, the regulating circuit including two transistors connected to each other in parallel for regulating the load voltage. The linearly regulated power supply is capable of providing a greater current to the load and the components of the linearly regulated power supply can be used efficiently.

### BACKGROUND OF THE INVENTION

1. Field of the Invention

The present invention relates to regulating power supplies, and particularly to a linearly regulated power supply to providing a regulated voltage to a load mounted on a motherboard.

2. General Background

Linearly regulated power supplies are widely used to supply power to electronic devices, such as to a load on a motherboard of a computer. Such Linearly regulated power supplies are available in a wide variety of configurations for many different applications.

Referring to FIG. 1, a typical linearly regulated power supply includes a voltage reference circuit 1, a first sub-circuit 2, and a second sub-circuit 3. The voltage reference circuit 1 provides a first voltage reference U₁. The first voltage reference U₁ is divided into a second voltage reference U₂ by two resistors R₁ and R₂ connected in series. The first sub-circuit 2 receives a source voltage V_{CC}, and then provides an output voltage U₀ lower than the source voltage V_{CC}. The second sub-circuit 3 receives the output voltage U₀, and then provides a regulated load voltage to a load.

The first sub-circuit 2 includes a first error amplifier 21 and a first metal-oxide-semiconductor field-effect transistor (MOSFET) 23. The first error amplifier 21 has a non-inverting input terminal, an inverting input terminal, and an output terminal. The non-inverting input terminal of the first error amplifier 21 receives the first voltage reference U₁. The inverting input terminal of the first error amplifier 21 is connected to an output end of the first sub-circuit 2 for sensing the output voltage U₀. The output terminal of the first error amplifier 21 is connected to a gate of the first MOSFET 23 for driving the first MOSFET 23. The first MOSFET 23 may be controlled to provide the output voltage U₀ regulated by the first sub-circuit 2. The second sub-circuit 3 includes a second error amplifier 31 and a second MOSFET 33. The second error amplifier 31 has a non-inverting input terminal, an inverting input terminal, and an output terminal. The non-inverting input terminal of the second error amplifier 31 receives the second voltage reference U₂. The inverting input terminal of the second error amplifier 31 is connected to an output end of the second sub-circuit 3 for sensing the load voltage. The output terminal of the second error amplifier 31 is connected to a gate of the second MOSFET 33 for driving the second MOSFET 33. The second MOSFET 33 is controlled to provide the load voltage regulated by the second sub-circuit 3 to the load.

However, a linearly regulated power supply has a disadvantage that a current flowing through the first MOSFET 23 and the second MOSFET 33 is limited since the first MOSFET 23 and the second MOSFET 33 are connected in series. When the rated currents of the first MOSFET 23 and the second MOSFET 33 are different, the current through the two MOSFETs 23, 33 must be lower than a rated current of the MOSFET 23, 33 that has a lower rated current. In such case, the other MOSFET 23, 33 that has a higher rated current cannot be utilized efficiently.

What is needed, therefore, is a linearly regulated power supply which is able to provide a greater current to a load and utilize components of a circuit efficiently.

### SUMMARY

A linearly regulated power supply is provided for providing a regulated load voltage to a load. In a preferred embodiment, the linearly regulated power supply includes: a voltage reference circuit for providing a first voltage reference; a resistive voltage divider connected to the voltage reference circuit for receiving the first voltage reference and then providing a second voltage reference; an error amplifier for receiving the second voltage reference and providing a controlling voltage; and a regulating circuit controlled by the controlling voltage, the regulating circuit receiving a source voltage and then providing a load voltage to a load, the regulating circuit including two transistors connected to each other in parallel for regulating the load voltage.

The linearly regulated power supply is capable of providing a greater current to the load, and components of the linearly regulated power supply can be utilized efficiently.

Other advantages and novel features will become more apparent from the following detailed description of preferred embodiments when taken in conjunction with the accompanying drawings, in which:

### BRIEF DESCRIPTION OF THE DRAWINGS

FIG. 1 is a circuit diagram of a typical linearly regulated power supply;

FIG. 2 is a circuit diagram of a linearly regulated power supply of a first preferred embodiment of the present invention; and

FIG. 3 is a circuit diagram of a linearly regulated power supply of a second preferred embodiment of the present invention.

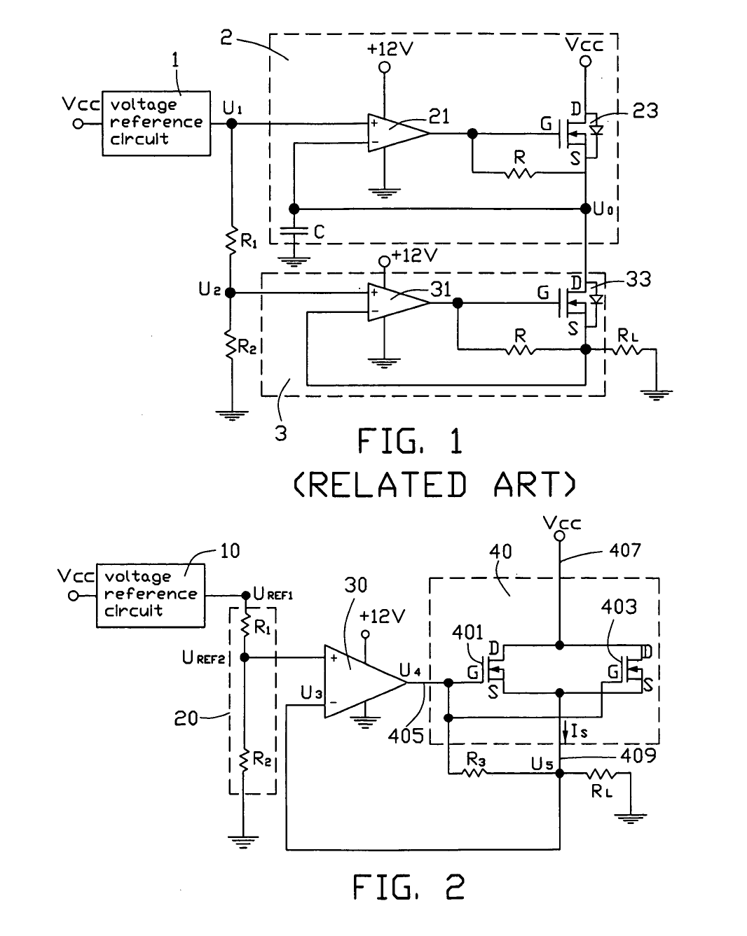

### DETAILED DESCRIPTION OF THE EMBODIMENTS

As shown in FIG. 2, in one embodiment of the present invention, a linearly regulated power supply includes a voltage reference circuit 10, a resistive voltage divider 20, an error amplifier 30 as a voltage stabilizer, and a regulating circuit 40 having regulating means therein.

The voltage reference circuit 10 provides a first voltage reference U_{REF1} to the resistive voltage divider 20. The resistive voltage divider 20 includes a resistor R₁ and a resistor R₂ connected to each other in series between the voltage reference circuit 10 and ground. A node between the resistor R₁ and the resistor R₂ provides a second voltage reference U_{REF2} to the error amplifier 30. The error amplifier 30 has a non-inverting input terminal as a first input terminal; an inverting input terminal as a second input terminal, and an output terminal. The non-inverting input terminal of the error amplifier 30 is connected to the resistive voltage divider 20 for receiving the second voltage reference U_{REF2}. The inverting input terminal of the error amplifier 30 is connected to a load R_{L} for sensing a load voltage U₅, and receives a feedback voltage U₃. The output terminal of the error amplifier 30 is connected to the regulating circuit 40 to provide a controlling voltage U₄ for controlling the regulating circuit 40. The regulating circuit 40 includes a first transistor 401 and a second transistor 403 as the regulating means, a gate terminal 405, a drain terminal 407, and a source terminal 409. The first transistor 401 and the second transistor 403 are N-channel MOSFETs. The first transistor 401 is connected to the second transistor 403 in parallel. Gates of the first transistor 401 and the second transistor 403 are connected to the gate terminal 405 of the regulating circuit 40. Drains of the first transistor 401 and the second transistor 403 are connected to the drain terminal 407 of the regulating circuit 40. Sources of the first transistor 401 and the second transistor 403 are connected to the source terminal 409 of the regulating circuit 40. The gate terminal 405 is connected to the output terminal of the error amplifier 30 for receiving the controlling voltage U₄. The drain terminal 407 receives a source voltage V_{CC}. The source terminal 409 is connected to the load R_{L} for providing the load voltage U₅ regulated by the regulating circuit 40. The gate terminal 405 is connected to the source terminal 409 via a resistor R₃. The voltage reference circuit 10 and the resistive voltage divider 20 cooperatively constitute a reference circuit for providing a voltage reference to the error amplifier 30.

When the load voltage U₅ suddenly becomes higher, the feedback voltage U₃ of the inverting terminal of the error amplifier 30 becomes higher too. The controlling voltage U₄ becomes lower correspondingly. Then a voltage U_{GS} (not shown in FIG. 2) between the gate terminal 405 and the source terminal 409 of the regulating circuit 40 becomes lower. The decrease of the voltage U_{GS} induces a reduction of a current Is of the source terminal 409. Therefore the load voltage U₅ drops to a same level as before the sudden increase thereof.

Contrarily, when the load voltage U₅ suddenly becomes lower, the feedback voltage U₃ of the inverting terminal of the error amplifier 30 becomes lower too. The controlling voltage U₄ becomes higher correspondingly. Then the voltage U_{GS} between the gate terminal 405 and the source terminal 409 of the regulating circuit 40 becomes higher. The increase of the voltage U_{GS} induces an enhancing of the current Is of the source terminal 409. Therefore the load voltage U₅ climbs to a same level as before the sudden decrease thereof.

In the illustrated embodiment, because that the first transistor 401 is connected to the second transistor 403 in parallel, a maximum current flowing through the regulating circuit 40 is equal to a sum of rated currents of the first transistor 401 and the second transistor 403. Therefore the linearly regulated power supply can provide a greater current to the load R_{L} than the typical linearly regulated power supply can do, and components of the linearly regulated power supply can be utilized efficiently.

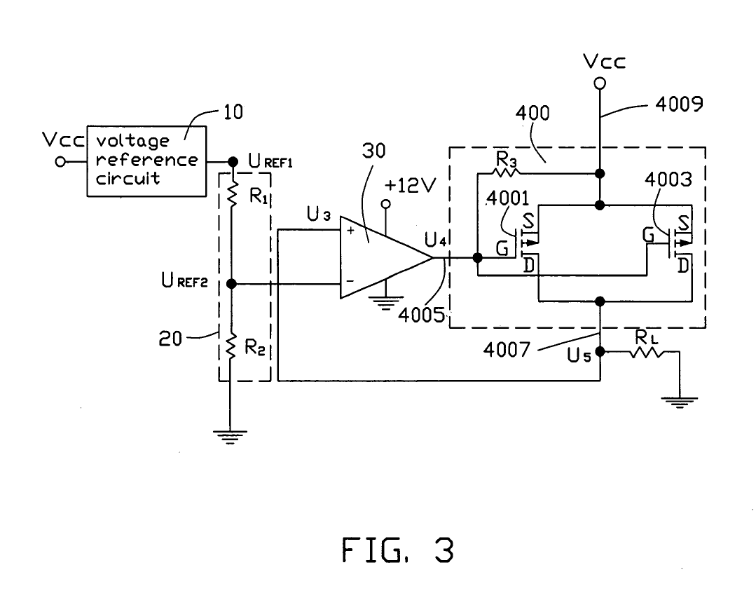

As shown in FIG. 3, in another embodiment of the present invention, an inverting input terminal of the error amplifier 30 as the first input terminal is connected to the resistive voltage divider 20 for receiving the voltage reference U_{REF2}, and a non-inverting input terminal of the error amplifier 30 as the second input terminal is connected to the load R_{L} for sensing the load voltage U₅ and receiving the feedback voltage U₃. A regulating circuit 400 includes a first transistor 4001, a second transistor 4003, a gate terminal 4005, a drain terminal 4007, and a source terminal 4009. The first transistor 4001 and the second transistor are P-channel MOSFETs. Gates of the first transistor 4001 and the second transistor 4003 are connected to the gate terminal 4005 of the regulating circuit 400. Sources of the first transistor 4001 and the second transistor 4003 are connected to the source terminal 4009 of the regulating circuit 400. Drains of the first transistor 4001 and the second transistor 4003 are connected to the drain terminal 4007 of the regulating circuit 400. The gate terminal 4005 is connected to the output terminal of the error amplifier 30. The source terminal 4009 receives a source voltage V_{CC}. The drain terminal 4007 is connected to the load R_{L} for providing the load voltage U₅ regulated by the regulating circuit 40.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A linearly regulated power supply comprising:
a voltage reference circuit for providing a first voltage reference;
a resistive voltage divider connected to the voltage reference circuit for receiving the first voltage reference and then providing a second voltage reference;
an error amplifier for receiving the second voltage reference and providing a controlling voltage; and
a regulating circuit controlled by the controlling voltage, the regulating circuit receiving a source voltage and then providing a load voltage to a load, the regulating circuit including two transistors connected to each other in parallel for regulating the load voltage.

2. The linearly regulated power supply as claimed in claim 1, wherein the resistive voltage divider comprises two resistors connected to each other in series, and a node between the resistors for providing the second voltage reference to the error amplifier.

3. The linearly regulated power supply as claimed in claim 1, wherein the error amplifier includes a non-inverting input terminal connected to the resistive voltage divider for receiving the second voltage reference, an inverting input terminal connected to the load for sensing the load voltage, and an output terminal connected to the regulating circuit for controlling the regulating circuit.

4. The linearly regulated power supply as claimed in claim 3, wherein the transistors are N-channel MOSFETs (metal-oxide-semiconductor field-effect transistors).

5. The linearly regulated power supply as claimed in claim 4, wherein the regulating circuit has a gate terminal connected to gates of the transistors, a source terminal connected to sources of the transistors, and a drain terminal connected to drains of the transistors.

6. The linearly regulated power supply as claimed in claim 5, wherein the drain terminal of the regulating circuit receives the source voltage, and the source terminal of the regulating circuit is connected to the load for providing the load voltage regulated by the regulating circuit.

7. The linearly regulated power supply as claimed in claim 1, wherein the error amplifier includes an inverting input terminal connected to the resistive voltage divider for receiving the second voltage reference, a non-inverting input terminal connected to the load for sensing the load voltage, and an output terminal connected to the regulating circuit for controlling the regulating circuit.

8. The linearly regulated power supply as claimed in claim 7, wherein the transistors are P-channel MOSFETs (metal-oxide-semiconductor field-effect transistors).

9. The linearly regulated power supply as claimed in claim 8, wherein the regulating circuit has a gate terminal connected to gates of the transistors, a source terminal connected to sources of the transistors, and a drain terminal connected to drains of the transistors.

10. The linearly regulated power supply as claimed in claim 9, wherein the source terminal of the regulating circuit receives the source voltage, and the drain terminal of the regulating circuit is connected to the load for providing the load voltage regulated by the regulating circuit.

11. A linearly regulated power supply comprising:
a reference circuit for providing a voltage reference;
an error amplifier for receiving the voltage reference and providing a controlling voltage; and
a regulating circuit controlled by the controlling voltage, the regulating circuit receiving a source voltage and then providing a regulated load voltage to a load, the regulating circuit including two transistors connected to each other in parallel for regulating the load voltage.

12. The linearly regulated power supply as claimed in claim 11, wherein the error amplifier includes a first input terminal connected to the reference circuit for receiving the voltage reference, a second input terminal connected to the load for sensing the load voltage, and an output terminal connected to the regulating circuit for controlling the regulating circuit.

13. The linearly regulated power supply as claimed in claim 11, wherein the regulating circuit has a gate terminal connected to gates of the transistors, a source terminal connected to sources of the transistors, and a drain terminal connected to drains of the transistors.

14. The linearly regulated power supply as claimed in claim 13, wherein the transistors are N-channel MOSFETs (metal-oxide-semiconductor field-effect transistors), the drain terminal of the regulating circuit receives a source voltage, and the source terminal of the regulating circuit is connected to the load for providing the load voltage regulated by the regulating circuit.

15. The linearly regulated power supply as claimed in claim 13, wherein the transistors are P-channel MOSFETs (metal-oxide-semiconductor field-effect transistors), the source terminal of the regulating circuit receives a source voltage, and the drain terminal of the regulating circuit is connected to the load for providing the load voltage regulated by the regulating circuit.

16. A method to regulate a power supply, comprising the steps of:
providing a voltage reference as a source of a power supply;
installing at least two regulating means in a regulating circuit so as to have said at least two regulating means accepting a same input of said regulating circuit and providing contributorily a same output of said regulating circuit;
electrically connecting said regulating circuit with an electrical load capable of using power of said power supply so as to provide said output of said regulating circuit to said load; and
electrically connecting a voltage stabilizer between said voltage reference and said regulating device so that said voltage stabilizer accepts said voltage reference and said output of said regulating circuit, and generates said input into said regulating circuit.

17. The method as claimed in claim 16, wherein said at least two regulating means of said regulating circuit are two parallel-connected transistors including metal-oxide semiconductor field-effect transistors (MOSFET).

18. The method as claimed in claim 16, further comprising the step of electrically connecting said at least two regulating means of said regulating circuit with a same source voltage in order to provide said output of said regulating circuit.

19. The method as claimed in claim 16, wherein said voltage stabilizer is an error amplifier.
